(19) United States
(12) Patent Application Publication
(10) Pub. No.: US 2026/0312522 A1
(43) Pub. Date: Oct. 8, 2026

(54) MOTOR CONTROL CIRCUIT, CONTROL METHOD, MOTOR ASSEMBLY AND ELECTRONIC DEVICE

(71) Applicant: Silergy Semiconductor Technology (Hangzhou) LTD, Hangzhou (CN)

(72) Inventors: Zhenfeng Zhong, Hangzhou (CN); Xuecheng Bai, Hangzhou (CN); Junpeng Cao, Hangzhou (CN); Kunlei Jia, Hangzhou (CN)

(21) Appl. No.: 19/637,208

(22) Filed: Apr. 2, 2026

(30) Foreign Application Priority Data
Apr. 8, 2025 (CN) 202510436231.5

(51) Int. Cl. H02P 23/00; H02K 7/14; H02K 11/33; H02P 1/02

(52) U.S. Cl. CPC H02P 23/0027; H02K 7/14; H02K 11/33; H02P 1/02

(57) ABSTRACT

A motor control circuit can include: a first pin; a second pin; a control logic circuit configured to control a motor based on a control signal received on the first pin, and to transmit a feedback signal representing operating information of the motor to the second pin in a non-four-wire control mode; a data communication circuit configured to use the first pin as a first signal terminal of a communication interface and the second pin as a second signal terminal of the communication interface in a four-wire control mode; where an operating frequency and/or duty cycle of the non-four-wire control mode is different from that of the four-wire control mode; andwhere the motor control circuit is configured to determine whether to switch to the four-wire control mode according to whether a mode switching signal is detected on the first pin or the second pin.

### RELATED APPLICATIONS

This application claims the benefit of Chinese Patent Application No. 202510436231.5, filed on Apr. 8, 2025, which is incorporated herein by reference in its entirety.

### FIELD OF THE INVENTION

The present invention generally relates to the field of power electronics, and more particularly to motor control circuits, methods, assemblies, and electronic devices.

### BACKGROUND

Motor control circuits are typically integrated with a fan, receiving control signals from a host controller (e.g., a microcontroller or a control chip in a motherboard), in order to control the motor of the fan. However, during research and development, it may be necessary to control the motor normally while also communicating with the motor control circuit for parameter configuration during online debugging. To reduce the number of connecting wires, the connection lines between the motor control circuit and the host controller may be multiplexed. Existing motor control circuits may only support communication within an extremely short time window after the circuit is powered on or exits a sleep mode to enter a four-wire control mode. This can increase the difficulty for both the response speed requirements of the host controller, and system debugging during research and development.

### BRIEF DESCRIPTION OF THE DRAWINGS

FIG. 1 is a schematic circuit diagram of an example electronic device including a motor control circuit, in accordance with embodiments of the present invention.

FIG. 2 is a schematic circuit diagram of a first example motor control circuit, in accordance with embodiments of the present invention.

FIG. 3 is a waveform diagram of a signal received at a first pin of the motor control circuit, in accordance with embodiments of the present invention.

FIG. 4 is a schematic circuit diagram of a first example first multiplexing circuit, in accordance with embodiments of the present invention.

FIG. 5 is a schematic circuit diagram of a first example second multiplexing circuit, in accordance with embodiments of the present invention.

FIG. 6 is a schematic circuit diagram of a second example motor control circuit, in accordance with embodiments of the present invention.

FIG. 7 is a schematic circuit diagram of a second example first multiplexing circuit, in accordance with embodiments of the present invention.

FIG. 8 is a schematic circuit diagram of a second example second multiplexing circuit, in accordance with embodiments of the present invention.

FIG. 9 is a flowchart of an example control method for a motor control circuit, in accordance with embodiments of the present invention.

### DETAILED DESCRIPTION

Reference may now be made in detail to particular embodiments of the invention, examples of which are illustrated in the accompanying drawings. While the invention may be described in conjunction with the preferred embodiments, it may be understood that they are not intended to limit the invention to these embodiments. On the contrary, the invention is intended to cover alternatives, modifications and equivalents that may be included within the spirit and scope of the invention as defined by the appended claims. Further, in the following detailed description of the present invention, numerous specific details are set forth in order to provide a thorough understanding of the present invention. However, it may be readily apparent to one skilled in the art that the present invention may be practiced without these specific details. In other instances, well-known methods, procedures, processes, components, structures, and circuits have not been described in detail so as not to unnecessarily obscure aspects of the present invention.

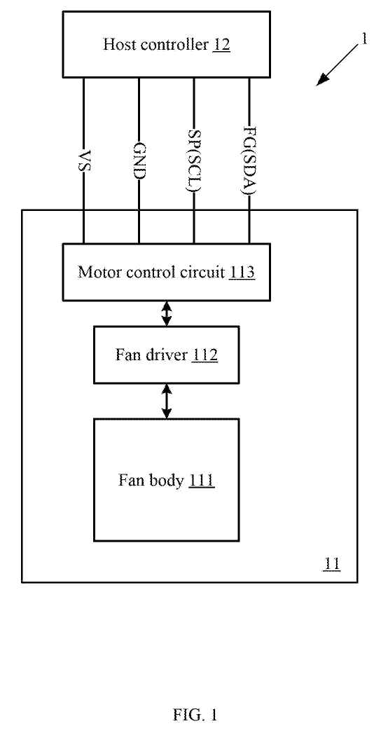

Referring now to FIG. 1, shown is a schematic circuit diagram of an example electronic device including a motor control circuit, in accordance with embodiments of the present invention. In this particular example, electronic device 1 can include at least one motor assembly 11 and host controller 12. In the following examples, a motor assembly used in a cooling fan is described. The motor assembly and the motor control circuit of particular embodiments can be applied in other scenarios, such as drive motors in robots. In this particular example, motor assembly 11 is an integrated fan assembly configured to blow out or draw in airflow according to the control of host controller 12 for heat dissipation. In particular embodiments, the electronic device can be a server or other product requiring fan cooling. Multiple motor assemblies 11 can be arranged at different positions within the server chassis for heat dissipation by drawing air in from the outside or blowing air out. Host controller 12 can be, e.g., a control chip on a server motherboard, or a dedicated microcontroller or other type of controller.

Motor assembly 11 can include fan body 111, fan driver 112, and motor control circuit 113. Fan body 111 may include a fan motor, fan blades, and necessary transmission components. Fan driver 112 can connect to the fan motor of fan body 111 and can output alternating current (AC) or direct current (DC) to drive the motor to rotate. Motor control circuit 113 can be fixedly mounted on the fan body and can receive control signals from host controller 12, generate specific drive signals accordingly, send them to fan driver 112, and control the fan driver to generate the voltage and current for driving the fan motor. In some implementations, the fan driver can be an inverter circuit. As shown in FIG. 1, motor control circuit 113 can connect to host controller 12 via only four pins to minimize the number of cables. These pins include power supply pin VS, ground pin GND, pin SP, and pin FG. Pin SP can receive a speed control signal from host controller 12.

In some embodiments, the speed control signal is a pulse-width modulation (PWM) signal, and the desired fan speed can be set for motor control circuit 113 based on the frequency and/or duty cycle of the signal. Pin FG can be a feedback pin in the non-four-wire control mode, used to send feedback information to host controller 12. Typically, the feedback signal represents the actual rotational speed of the fan motor. The actual rotational speed can be obtained from feedback from the fan motor itself or detected by additional sensors. Thus, host controller 12 can perform closed-loop control based on the transmitted speed control signal and the received feedback signal, thus ensuring the accuracy of fan control.

In addition, in the four-wire control mode, motor control circuit 113 can multiplex pins SP and FG as signal terminals of a communication interface, transmitting and receiving communication signals via pins SP and FG. In one particular example, the communication interface is a serial communication interface, such as an IIC (Inter-Integrated Circuit) serial communication interface. IIC is a bidirectional, two-wire, synchronous serial communication interface suitable for short-distance inter-chip communication that uses two buses: a serial data line (SDA) and a serial clock line (SCL). Due to its relatively simple protocol and high efficiency, IIC is widely used for connecting microcontrollers to low-speed peripherals, such as EEPROMs and sensors, and is a common communication standard in embedded systems, suitable for industrial control, consumer electronics, and other fields.

In one particular example, pin SP can be multiplexed as clock line pin SCL, and pin FG as data line pin SDA. Since the signal frequency of serial communication, e.g., IIC serial communication, can be higher than 400 kHz, while the frequencies of common speed control signals and feedback signals are typically below 100 kHz, the difference in frequency between these two types of signals may allow for pin multiplexing. For example, within motor control circuit 113, the signal frequency on pins SP and FG is determined. If the signal frequency falls within a predetermined first frequency range (e.g., above 400 kHz as mentioned), it can be processed as an IIC serial communication signal. If the signal frequency falls within a predetermined second frequency range (where the first and second frequency ranges are different and non-overlapping, e.g., below 100 kHz), the signal can be processed according to the pin's original function.

As another example, multiple filter circuits can be added to filter out different frequency components in different branches, and the filtered signals can then be further processed according to speed control signals or serial communication signals. As yet another example, multiple multiplexing circuits can be added, and in different branches, based on a signal indicating the operating mode, the signal of the corresponding pin matching the operating mode can be selected from the signals of multiple pins and sent to the next stage for further processing.

In one embodiment, in the four-wire control mode, motor control circuit 113 may act as a slave to host controller 12, communicating with host controller 12 via the serial communication interface. Host controller 12 can write configuration status information to a register of motor control circuit 113 via the serial communication interface, thereby controlling motor control circuit 113 to exit the four-wire control mode and enter the non-four-wire control mode based on the written configuration status information. In this case, "non-four-wire control mode" may refer to one or more operating modes of motor control circuit 113 other than the "four-wire control mode." In the "non-four-wire control mode," pins SP and FG may not be multiplexed as signal terminals of the communication interface. In these operating modes, motor control circuit 113 can rely on four or more wires or pins to interact with host controller 12 to receive control signals. When the non-four-wire control mode has multiple different operating modes, exiting the four-wire control mode can be entering a specific non-four-wire control mode according to a priority order, randomly entering a certain non-four-wire control mode, or entering a corresponding specific non-four-wire control mode according to the indication of the configuration status information. In one embodiment, motor control circuit 113 can be implemented in different forms, such as an integrated circuit or a circuit board.

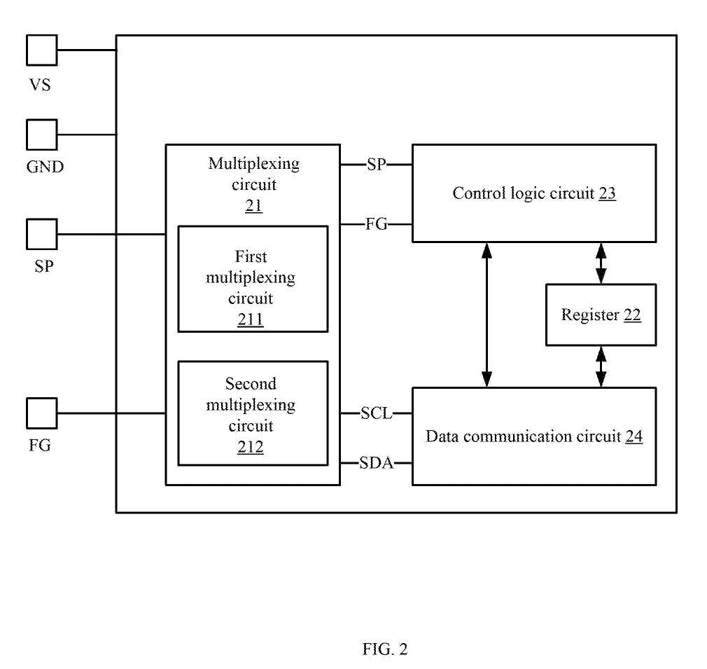

Referring now to FIG. 2, shown is a schematic circuit diagram of a first example motor control circuit, in accordance with embodiments of the present invention. In this particular example, the motor control circuit can include power supply pin VS, ground pin GND, pin SP, pin FG, multiplexing circuit 21, register 22, control logic circuit 23, and data communication circuit 24. Power supply pin VS may receive a power supply signal. Ground pin GND can connect to a ground reference terminal, providing a power ground for the motor control circuit. Besides supplying power to the subsequent fan driver 112, power supply pin VS and ground pin GND also need to supply power to different modules within motor control circuit 113.

Pin SP may receive a speed control signal in the non-four-wire control mode. Pin FG can be used for externally transmitting a feedback signal in the non-four-wire control mode, where the feedback signal represents the actual rotational speed of the fan. Control logic circuit 23 can connect to a motor external to the motor control circuit via several other pins for controlling the motor's operation. Register 22 can connect to control logic circuit 23 and data communication circuit 24 for storing configuration status information. Both control logic circuit 23 and data communication circuit 24 can connect to multiplexing circuit 21. For example, in the non-four-wire control mode, control logic circuit 23 may receive the control signal from pin SP via multiplexing circuit 21, and transmit the generated feedback signal to pin FG. In the four-wire control mode, data communication circuit 24 can be indirectly connected to pins SP and FG via multiplexing circuit 21 for communicating clock signals and data signals of the communication interface. Data communication circuit 24 can send received data to control logic circuit 23, or receive data from control logic circuit 23 that needs to be sent to the host controller based on the communication interface.

For example, the motor control circuit can perform the following steps. In response to motor control circuit 113 being in the non-four-wire control mode, the signal on pin SP can be detected. In response to detecting a mode switching signal on pin SP, the motor control circuit can switch to the four-wire control mode. The mode switching signal may have a predetermined frequency and/or duty cycle. In one embodiment, in the four-wire control mode, pin SP can be multiplexed as clock line SCL (e.g., the first signal terminal) of the IIC serial communication interface, and pin FG can be multiplexed as data line SDA (e.g., the second signal terminal) of the IIC serial communication interface. Thus, upon entering the four-wire control mode, data communication circuit 24 can transmit communication signals of the IIC serial communication interface, which may have a relatively high frequency, via pin SP and/or pin FG, thereby reading from and writing to register 22 of the motor control circuit. That is, data communication circuit 24 can read from and write to the register based on input signals on the first pin and the second pin in the four-wire control mode. To exit the four-wire control mode, configuration status information indicating an exit from the four-wire control mode can be written to register 22 via pins SP and FG. The configuration status information may be one or more bytes of status flags stored in a predetermined address range of the register.

Simultaneously, motor control circuit 113 may switch to the non-four-wire control mode in response to the configuration status information indicating an exit from the four-wire control mode. In one particular example, if multiple different non-four-wire control modes exist, the writable different configuration status information may correspond to different non-four-wire control modes, and motor control circuit 113 can switch to a corresponding one of the non-four-wire control modes based on the configuration status information.

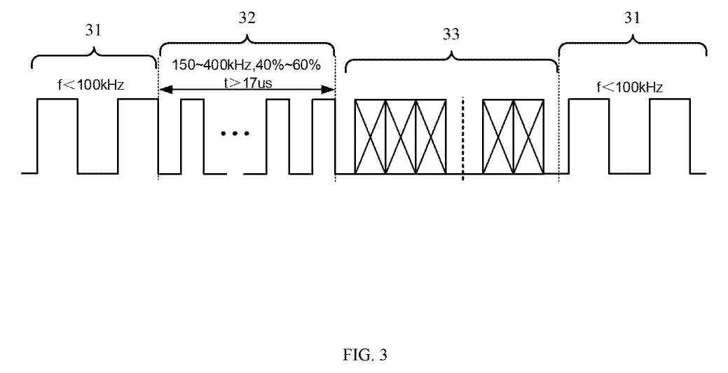

Referring now to FIG. 3, shown is a waveform diagram of a signal received at a first pin of the motor control circuit, in accordance with embodiments of the present invention. In this particular example, in the non-four-wire control mode, pin SP can receive a speed control signal from the host controller. For example, speed control signal 31 can be a PWM signal with a frequency less than 100 kHz. Here, pin SP may not be multiplexed. To control the motor control circuit to switch to the four-wire control mode, the host controller may input electrical signal 32 having attributes that satisfy the switching condition to pin SP. The attributes of this electrical signal may be different from the speed control signal, thus enabling motor control circuit 113 to use the frequency and/or duty cycle of the signal as a determination condition for switching. In one particular example, both the frequency and duty cycle of the electrical signal can be used simultaneously to determine whether the electrical signal applied to pin SP is a mode switching signal.

Further, a duration limit for the detected mode switching signal can be added to avoid erroneous switching caused by accidental external electromagnetic interference. For example, the mode switching signal for indicating a switch to the four-wire control mode may have a frequency between 150 kHz and 400 kHz, a duty cycle between 40% and 60%, and a duration greater than 17 microseconds. For example, the frequency range of the electrical signal for indicating a switch to the four-wire control mode can be limited to 200-250 kHz, the duty cycle of the electrical signal can be limited to 50%-55%, and the duration of the electrical signal can be greater than 20 microseconds. As long as an electrical signal satisfying the above switching conditions is detected on pin SP while in the non-four-wire control mode, the four-wire control mode enable signal can be enabled, thereby switching to the four-wire control mode. In the four-wire control mode, the four-wire control mode enable signal can be asserted, thereby indicating the current operating mode, and causing multiplexing circuit 21 to process the signals on the corresponding multiplexed pins and switch to a mode where the signals on pins SP and FG are processed as the clock signal or communication signal of the communication interface.

In the above example, to avoid misjudgment caused by signal interference, the signal's frequency, duty cycle, and duration simultaneously meeting requirements can be used as the switching determination condition. In other implementations, the mode switching signal may only require its frequency to be within a predetermined range different from the speed control signal, or only its duty cycle to be within a range different from the speed control signal, and may or may not impose a requirement on the duration of the mode switching signal.

In the four-wire control mode, if it is desired to switch to the non-four-wire control mode, e.g., to exit the four-wire control mode, configuration status information indicating an exit from the four-wire control mode can be written to register 22 according to the write signal of data line SDA of IIC serial communication interface transmitted by multiplexed pin FG and clock signal 33 input on pin SP. As an example, the four-wire control mode enable signal can be controlled not to be enabled. In one embodiment, the write signal can be based on the IIC serial communication interface protocol and has a frequency greater than 400 kHz. If the configuration status information indicates an exit from the four-wire control mode and corresponds to one of multiple non-four-wire control modes, the circuit can switch to the non-four-wire control mode corresponding to the configuration status information. After exiting the four-wire control mode, the signal normally received on pin SP can become speed control signal 31 again.

Referring back to FIG. 2, in one example, multiplexing circuit 21 can include multiplexing circuits 211 and 212. Multiplexing circuit 211 can connect to pin SP, control logic circuit 23, and data communication circuit 24, and may output the signal from pin SP as a first communication signal of the communication interface to data communication circuit 24 according to four-wire control mode enable signal EN_4W. Multiplexing circuit 212 can connect to pin FG, control logic circuit 23, and data communication circuit 24, and may transmit and receive signals from pin FG according to four-wire control mode enable signal EN_4W.

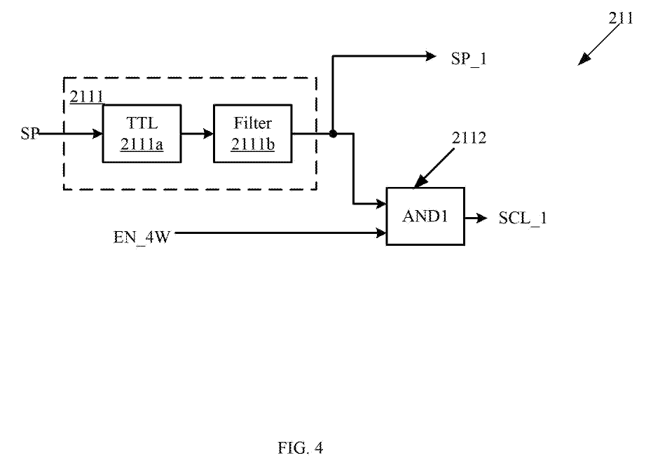

Referring now to FIG. 4, shown is a schematic circuit diagram of a first example first multiplexing circuit, in accordance with embodiments of the present invention. In this particular example, multiplexing circuit 211 can include input filter circuit 2111 and selection circuit 2112. An input terminal of input filter circuit 2111 can connect to pin SP, and an output terminal of input filter circuit 2111 can connect to speed control signal terminal SP_1 of control logic circuit 23 for receiving the speed control signal. Selection circuit 2112 may select whether to output the output signal of input filter circuit 2111 to data communication circuit 24 according to four-wire control mode enable signal EN_4W. For example, selection circuit 2112 may be AND gate AND1, which may receive four-wire control mode enable signal EN_4W and the output signal of input filter circuit 2111. Four-wire control mode enable signal EN_4W can be at a high level in the four-wire control mode and at a low level in the non-four-wire control mode. When four-wire control mode enable signal EN_4W is at a high level, the output signal of AND gate AND1 may follow the output signal of input filter circuit 2111, thereby transmitting the signal from pin SP to signal terminal SCL_1 of data communication circuit 24 for transmitting the clock signal in the four-wire control mode.

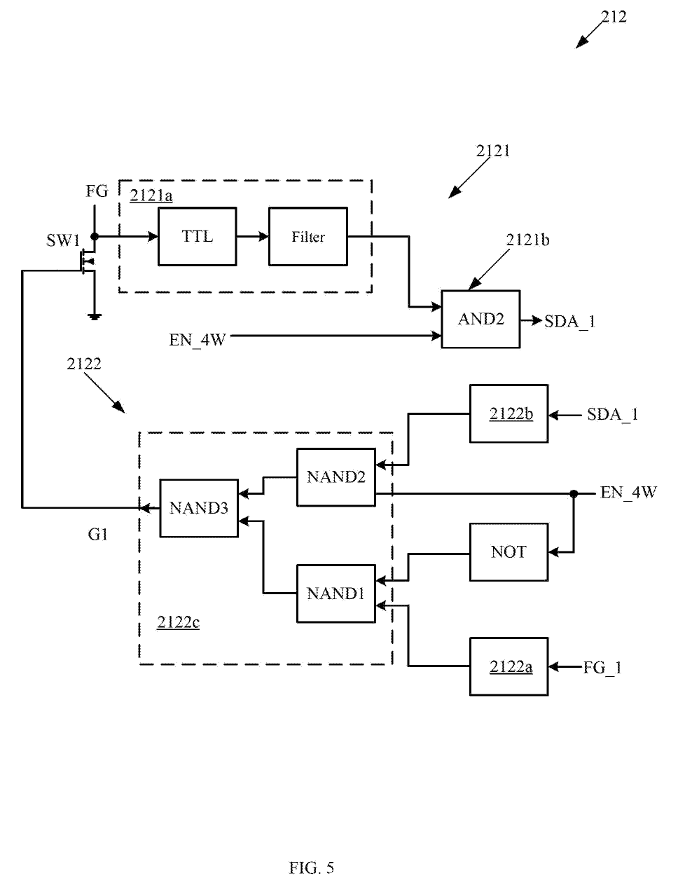

Referring now to FIG. 5, shown is a schematic circuit diagram of a first example second multiplexing circuit, in accordance with embodiments of the present invention. In this particular example, multiplexing circuit 212 can include reception multiplexing circuit 2121 and transmission multiplexing circuit 2122. Reception multiplexing circuit 2121 can connect to pin FG and data communication circuit 24, and may receive a signal from pin FG according to four-wire control mode enable signal EN_4W. Transmission multiplexing circuit 2122 can connect to pin FG, control logic circuit 23, and data communication circuit 24, and may transmit a data signal to be sent, originating from control logic circuit 23 or data communication circuit 24, from pin FG according to four-wire control mode enable signal EN_4W.

Reception multiplexing circuit 2121 can include input filter circuit 2121a and selection circuit 2121b. Input filter circuit 2121a can connect to the second pin and may filter the signal received on pin FG. Input filter circuit 2121a can include a TTL (Transistor-Transistor Logic) circuit and a filter. The TTL circuit can be used for level shifting the voltage of the input signal from pin FG. Selection circuit 2121b may select whether to output the output signal of input filter circuit 2121a to signal terminal SDA_1 of data communication circuit 24 for transmitting the data signal, according to four-wire control mode enable signal EN_4W. For example, selection circuit 2121b can include AND gate AND2, which may receive four-wire control mode enable signal EN_4W and the output signal of the second input filter circuit. Four-wire control mode enable signal EN_4W can be at a high level in the four-wire control mode and at a low level in the non-four-wire control mode. When four-wire control mode enable signal EN_4W is at a high level, the output signal of AND gate AND2 may follow the output signal of input filter circuit 2121a, thereby transmitting the signal from pin FG to signal terminal SDA_1 of data communication circuit 24 for transmitting the data signal in the four-wire control mode.

Transmission multiplexing circuit 2122 can include output filter circuit 2122a, output filter circuit 2122b, and selection circuit 2122c. Output filter circuit 2122a may receive a signal to be transmitted from the control logic circuit. Output filter circuit 2122b may receive a signal to be transmitted from signal terminal SDA_1 of data communication circuit 24. Selection circuit 2122c can select, according to four-wire control mode enable signal EN_4W, the output signal of either output filter circuit 2122a or output filter circuit 2122b as switch control signal G1. Switch SW1 can connect between pin FG and a reference terminal, and may be turned on or off under the control of switch control signal G1. For example, selection circuit 2122c can include NAND gates NAND1, NAND2, and NAND3. NAND gate NAND1 may receive the output signal of output filter circuit 2122a and an inverted signal of four-wire control mode enable signal EN_4W. NAND gate NAND2 may receive the output signal of output filter circuit 2122b and four-wire control mode enable signal EN_4W. NAND gate NAND3 may receive the output signals of NAND gates NAND1 and NAND2, and can output switch control signal G1. When four-wire control mode enable signal EN_4W is at a high level, e.g., in the four-wire control mode, selection circuit 2122c may filter the data signal to be transmitted from signal terminal SDA_1 of data communication circuit 24, and output it as switch control signal G1.

When four-wire control mode enable signal EN_4W is at a low level, e.g., in the non-four-wire control mode, selection circuit 2122c may filter the feedback signal to be transmitted from feedback signal terminal FG_1 of control logic circuit 23, and outputs it as switch control signal G1. Thus, under the control of switch control signal G1, switch SW1 may turn on or off according to the corresponding signal, thus generating a transmission signal with alternating high and low levels on pin FG for external transmission. When four-wire control mode enable signal EN_4W is at a high level, the inverted signal of four-wire control mode enable signal EN_4W is at a low level, the feedback signal to be transmitted from feedback signal terminal FG_1 of control logic circuit 23 may be blocked, and the output signal of NAND gate NAND3 can be determined by the data signal to be transmitted from signal terminal SDA_1 of data communication circuit 24. That is, the transmission signal on pin FG can be determined by the signal to be transmitted from signal terminal SDA_1 of data communication circuit 24. When four-wire control mode enable signal EN_4W is at a low level, the data signal to be transmitted from signal terminal SDA_1 of data communication circuit 24 can be blocked, and the output signal of NAND gate NAND3 can be determined by the feedback signal to be transmitted from feedback signal terminal FG_1 of control logic circuit 23.

Particular embodiments may utilize the signal characteristics of the pins used for transmitting and receiving signals in the motor control circuit in the four-wire control mode to transmit a mode switching signal via these pins. If a signal on the first pin satisfies a switching condition in the non-four-wire control mode, the circuit can switch to the four-wire control mode. Thus, unlike other approaches where switching is only possible within an extremely short time window, the host controller can conveniently switch between the four-wire control mode and the non-four-wire control mode at any time. This can reduce the response speed requirements for other system components and facilitates R&D debugging.

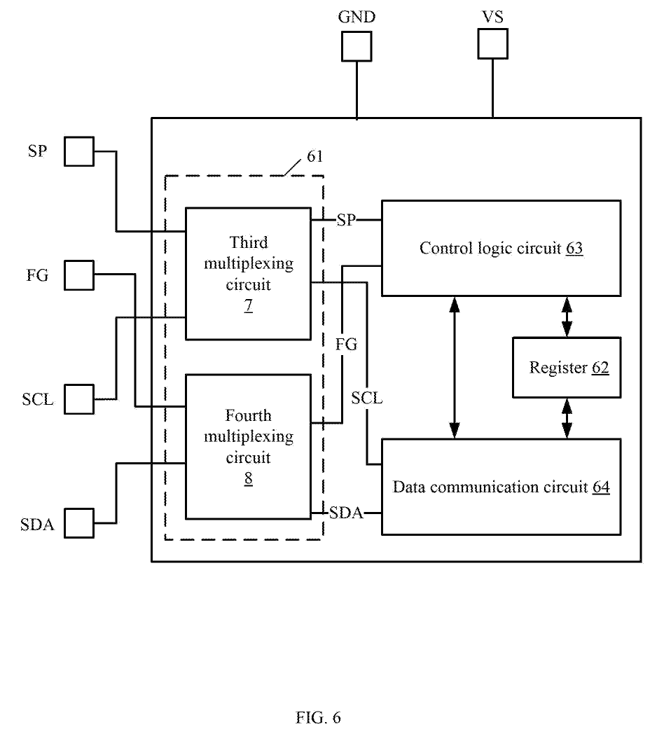

Referring now to FIG. 6, shown is a schematic circuit diagram of a second example motor control circuit, in accordance with embodiments of the present invention. In this particular example, the motor control circuit may provide a communication interface for external communication in the non-four-wire control mode. For example, the motor control circuit can include power supply pin VS, ground pin GND, pin SP, pin FG, pin SCL and pin SDA. The motor control circuit can also include multiplexing circuit 61, register 62, control logic circuit 63, and data communication circuit 64. Both control logic circuit 63 and data communication circuit 64 can connect to multiplexing circuit 61. Multiplexing circuit 61 can connect to pins SP, FG, SDA, and SCL. Multiplexing circuit 61 can switch its operating state according to four-wire control mode enable signal EN_4W. In the four-wire control mode, multiplexing circuit 61 can connect pins SP and FG as the first and second terminals of the communication interface to data communication circuit 64. Simultaneously, the signals from pins SCL and SDA can be blocked. In the non-four-wire control mode, multiplexing circuit 61 can connect pins SP and FG to control logic circuit 63, and can connect pins SCL and SDA to data communication circuit 64. Control logic circuit 63 may receive the speed control signal, and send the feedback signal based on pins SP and FG. Data communication circuit 64 can communicate via the communication interface formed by pin SCL and pin SDA.

Multiplexing circuit 61 can include multiplexing circuit 7 and multiplexing circuit 8. Multiplexing circuit 7 may receive the four-wire control mode enable signal and can connect to pin SCL, pin SP, control logic circuit 63, and data communication circuit 64. Multiplexing circuit 8 may receive the four-wire control mode enable signal and can connect to pin SDA, pin FG, control logic circuit 63, and data communication circuit 64. In the example shown in FIG. 6, the IIC serial communication interface can be used as the communication interface between the motor control circuit and the host controller for explanation. Pins SCL and SDA can be used as the first and second signal terminals of the communication interface in the non-four-wire control mode. Multiplexing circuits 7 and 8 can block the signals from pins SCL and SDA, and multiplex pins SP and FG as the first and second signal terminals of the IIC serial communication interface, respectively, in the four-wire control mode. Multiplexing circuit 7 can output the signal from pin SP or the signal from pin SCL as the first communication signal (e.g., clock signal) of the IIC serial communication interface according to the four-wire control mode enable signal. Multiplexing circuit 8 can transmit and receive signals from pin FG or pin SDA according to the four-wire control mode enable signal.

Multiplexing circuit 7 can be considered as a multiplexer that outputs the signal on pin SP or the signal on pin SCL to the corresponding terminal of data communication circuit 64 based on the four-wire control mode enable signal indicating the current operating mode. In addition, multiplexing circuit 8 can be considered a multi-channel reception and multi-channel transmission selector. Multiplexing circuit 8 can output the signal from pin FG or pin SDA to the corresponding terminal of control logic circuit 63 or data communication circuit 64 based on the four-wire control mode enable signal. Further, since data may be reported from data communication circuit 64 to host controller 12, multiplexing circuit 8 can also send data from control logic circuit 63 or data communication circuit 64 to pin FG (e.g., in four-wire control mode) or pin SDA (e.g., in non-four-wire control mode) based on the four-wire control mode enable signal. According to the four-wire control mode enable signal, multiplexing circuit 8 can send data to pin FG for transmission in the four-wire control mode, or to pin SDA for transmission in the non-four-wire control mode.

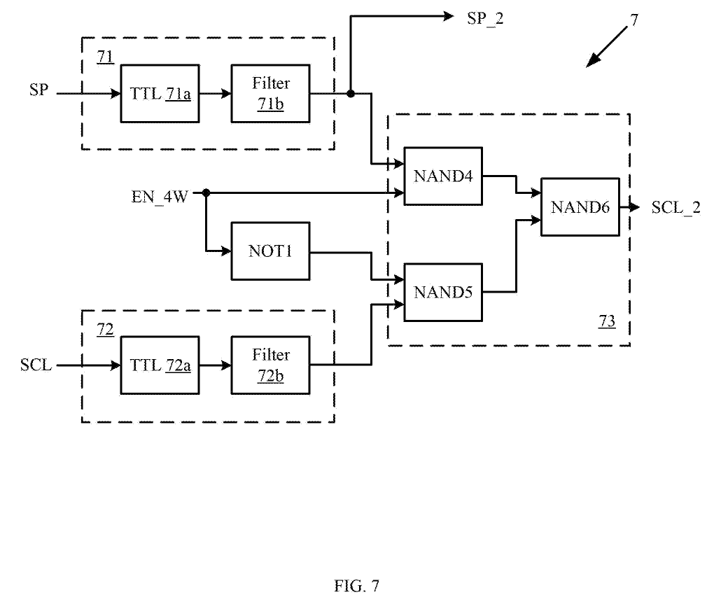

Referring now to FIG. 7, shown is a schematic circuit diagram of a second example first multiplexing circuit, in accordance with embodiments of the present invention. In this particular example, multiplexing circuit 7 can include input filter circuit 71, input filter circuit 72, and selection circuit 73. Input filter circuit 71 can connect to pin SP, and input filter circuit 72 can connect to pin SCL. Selection circuit 73 may select, according to four-wire control mode enable signal EN_4W, the output signal of either input filter circuit 71 or input filter circuit 72 as the clock signal, and output it to signal terminal SCL_2 of data communication circuit 64 for transmitting the clock signal. Input filter circuits 71 and 72 can filter the signals received on the corresponding pins. For example, each of input filter circuits 71 and 72 may include TTL circuits 71a and 72a, and filters 71b and 72b. TTL circuits 71a and 72a can be used for level shifting the voltage of the input signals on pins SP and SCL, respectively. In addition, an output terminal of input filter circuit 71 can connect to speed control signal terminal SP_2 of control logic circuit 23, for outputting the speed control signal to speed control signal terminal SP_2 of control logic circuit 23.

In one particular example, as shown in FIG. 7, selection circuit 73 can include NAND gate NAND4, NAND gate NAND5, and NAND gate NAND6. NAND gate NAND4 may receive four-wire control mode enable signal EN_4W and the output signal of input filter circuit 71, and the output terminal of NAND gate NAND4 can connect to NAND gate NAND6. NAND gate NAND5 may receive an inverted signal of four-wire control mode enable signal EN_4W and the output signal of input filter circuit 72, and the output terminal of NAND gate NAND5 can connect to NAND gate NAND6. To obtain the inverted signal of four-wire control mode enable signal EN_4W, inverter NOT1 can be added at the input terminal of NAND gate NAND5. NAND gate NAND6 may receive the output signal of NAND gate NAND4 and the output signal of NAND gate NAND5, and can output the clock signal to first signal terminal SCL_2 of data communication circuit 64 for transmitting the clock signal. Four-wire control mode enable signal EN_4W can be enabled (e.g., high level) in the four-wire control mode, and disabled (e.g., low level) in the non-four-wire control mode.

When in the four-wire control mode, the signal output by NAND gate NAND6 can be consistent with (e.g., the same level as) the input signal of pin SP, thus blocking the input signal of pin SCL. This may achieve the multiplexing of pin SP in the four-wire control mode. When in the non-four-wire control mode, the signal output by NAND gate NAND6 to the control logic circuit can be consistent with the output signal of pin SCL, thus blocking the input signal of pin SP. Four-wire control mode enable signal EN_4W could also be at a low level in the four-wire control mode and a high level in the non-four-wire control mode. Based on this, the structure of selection circuit 73 would need to be changed correspondingly. For example, four-wire control mode enable signal EN_4W can be stored in register 62.

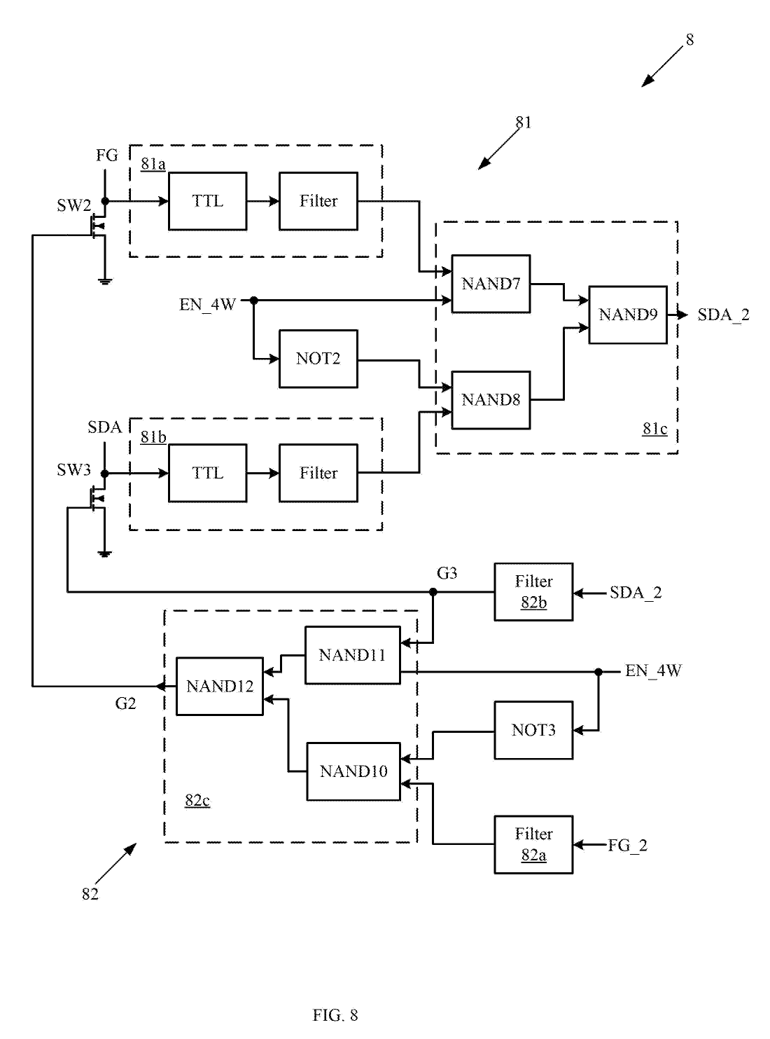

Referring now to FIG. 8, shown is a schematic circuit diagram of a second example second multiplexing circuit, in accordance with embodiments of the present invention. In this particular example, multiplexing circuit 8 can include reception multiplexing circuit 81 and transmission multiplexing circuit 82. Reception multiplexing circuit 81 can connect to pin FG, pin SDA, and data communication circuit 64, and may receive a signal from pin FG or pin SDA to data communication circuit 64 according to four-wire control mode enable signal EN_4W, where the received signal serves as a data signal. Transmission multiplexing circuit 82 can connect to pin FG, pin SDA, control logic circuit 63, and data communication circuit 64, and may transmit a signal to be sent, originating from control logic circuit 63 or data communication circuit 64, from pin FG or pin SDA to host controller 12 according to four-wire control mode enable signal EN_4W.

Reception multiplexing circuit 81 can include input filter circuit 81a, input filter circuit 81b, and selection circuit 81c. Input filter circuit 81a can connect to pin FG, and may filter signals input from pin FG to data communication circuit 64. Input filter circuit 81b can connect to pin SDA, and may filter signals input from pin SDA to data communication circuit 64. Input filter circuits 81a and 81b may have a similar structure, whereby each includes a TTL circuit and a filter. Selection circuit 81c can select, according to four-wire control mode enable signal EN_4W, the output signal of either input filter circuit 81a or input filter circuit 81b to output to signal terminal SDA_2 of data communication circuit 64 for transmitting the data signal.

In one particular example, selection circuit 81c can include NAND gate NAND7, NAND gate NAND8, and NAND gate NAND9. NAND gate NAND7 may receive four-wire control mode enable signal EN_4W and the output signal of input filter circuit 81a, and the output terminal of NAND gate NAND7 can connect to NAND gate NAND9. NAND gate NAND8 may receive an inverted signal of four-wire control mode enable signal EN_4W and the output signal of input filter circuit 81b, and the output terminal of NAND gate NAND8 can connect to NAND gate NAND9. To obtain the inverted signal of four-wire control mode enable signal EN_4W, inverter NOT2 can be added at the input of NAND gate NAND8. NAND gate NAND9 may receive the output signal of NAND gate NAND7 and the output signal of NAND gate NAND8, and may output the data signal to signal terminal SDA_2 of the data communication circuit. Four-wire control mode enable signal EN_4W can be at a high level in the four-wire control mode, and at a low level in the non-four-wire control mode.

When in the four-wire control mode, the signal output by NAND gate NAND9 can be consistent with the input signal of pin FG, thus blocking the input signal of pin SDA. This may achieve the multiplexing of pin FG in the four-wire control mode. When in the non-four-wire control mode, the signal output by NAND gate NAND9 to the control logic circuit can be consistent with the output signal of pin SDA, thus blocking the input signal of pin FG. Four-wire control mode enable signal EN_4W could also be at a low level in the four-wire control mode and a high level in the non-four-wire control mode. Based on this, the structure of selection circuit 81c would need to be changed correspondingly.

For example, transmission multiplexing circuit 82 can include output filter circuit 82a, output filter circuit 82b, selection circuit 82c, switch SW2, and switch SW3. Output filter circuit 82a may receive a feedback signal to be transmitted from feedback signal terminal FG_2 of control logic circuit 63, and may perform filtering. The feedback signal to be transmitted can be an analog signal, which may be generated by control logic circuit 63 and then converted via a digital-to-analog converter. Output filter circuit 82b can receive a data signal to be transmitted from signal terminal SDA_2 of the data communication circuit, and may perform filtering. Similarly, the data signal to be transmitted can be an analog signal, which may be generated by data communication circuit 64 and then converted via a digital-to-analog converter. Output filter circuits 82a and 82b may use, e.g., 50ns filters. Selection circuit 82c can select, according to four-wire control mode enable signal EN_4W, the output signal of either output filter circuit 82a or output filter circuit 82b as switch control signal G2 to output. Switch SW2 can connect between pin FG and a reference terminal, and can be turned on or off under the control of switch control signal G2. Switch SW3 can connect between pin SDA and a reference terminal, and may be turned on or off under the control of the output signal of output filter circuit 82b.

When four-wire control mode enable signal EN_4W is at a high level, e.g., in the four-wire control mode, selection circuit 82c can output the filtered data signal to be sent from signal terminal SDA_2 of the data communication circuit as switch control signal G2. When four-wire control mode enable signal EN_4W is at a low level, e.g., in the non-four-wire control mode, selection circuit 82c can output the filtered feedback signal to be sent from feedback signal terminal FG_2 of control logic circuit 63 as switch control signal G2. Thus, under the control of switch control signal G2, switch SW2 can turn on or off according to the corresponding signal, thus generating a transmission signal with alternating high and low levels on pin FG for external transmission. For example, selection circuit 82c can include NAND gate NAND10, NAND gate NAND11, and NAND gate NAND12. NAND gate NAND10 may receive the output signal of output filter circuit 82a and an inverted signal of four-wire control mode enable signal EN_4W. To obtain the inverted signal of four-wire control mode enable signal EN_4W, inverter NOT3 can be added at the input terminal of NAND gate NAND10. NAND gate NAND11 may receive the output signal of output filter circuit 82b and four-wire control mode enable signal EN_4W. NAND gate NAND12 may receive the output signals of NAND gates NAND10 and NAND11, and can output switch control signal G2.

When four-wire control mode enable signal EN_4W is at a high level, the inverted signal of four-wire control mode enable signal EN_4W can be at a low level, the feedback signal to be sent may be blocked, and the output signal of NAND gate NAND12 can be determined by the data signal to be sent from signal terminal SDA_2 of the data communication circuit. That is, the transmission signal on pin FG can be the data signal to be sent. When four-wire control mode enable signal EN_4W is at a low level, the data signal to be sent from signal terminal SDA_2 of the data communication circuit can be blocked, and the output signal of NAND gate NAND12 may be determined by the feedback signal to be sent from feedback signal terminal FG_2 of control logic circuit 63. In one example, the data signal to be sent may be an acknowledgment signal sent from data communication circuit 64 to the host controller, or other types of signals.

In the four-wire control mode example, pin SP can be multiplexed as the first signal terminal of the communication interface for transmitting the clock signal, and pin FG may be multiplexed as the second signal terminal of the communication interface for transmitting the data signal. In the non-four-wire control mode, pin SP may serve as a signal input pin (e.g., the clock signal is also an input signal), while pin FG may serve as a signal output pin. Therefore, in the four-wire control mode, pin SP can be multiplexed for clock signal transmission. In other examples, pin SP could also be multiplexed for data signal transmission in the four-wire control mode.

Particular embodiments may utilize the signal characteristics of the pins used for transmitting and receiving signals of the motor control circuit in the four-wire control mode to transmit a mode switching signal via these pins. If a signal on a corresponding pin satisfies a switching condition in the non-four-wire control mode, the circuit can switch to the four-wire control mode. Thus, unlike other approaches whereby switching is only possible within an extremely short time window, the host controller can conveniently switch between the four-wire control mode and the non-four-wire control mode at any time. This can reduce the response speed requirements for other system components and facilitates R&D debugging.

In one embodiment, upon power-up of the motor control circuit, the control logic circuit can automatically enter the non-four-wire control mode, and start detecting the signal on pin SP. When an electrical signal satisfying the switching condition is detected, the control logic circuit can switch to the four-wire control mode. If no electrical signal satisfying the switching condition is detected, it can operate in the non-four-wire control mode.

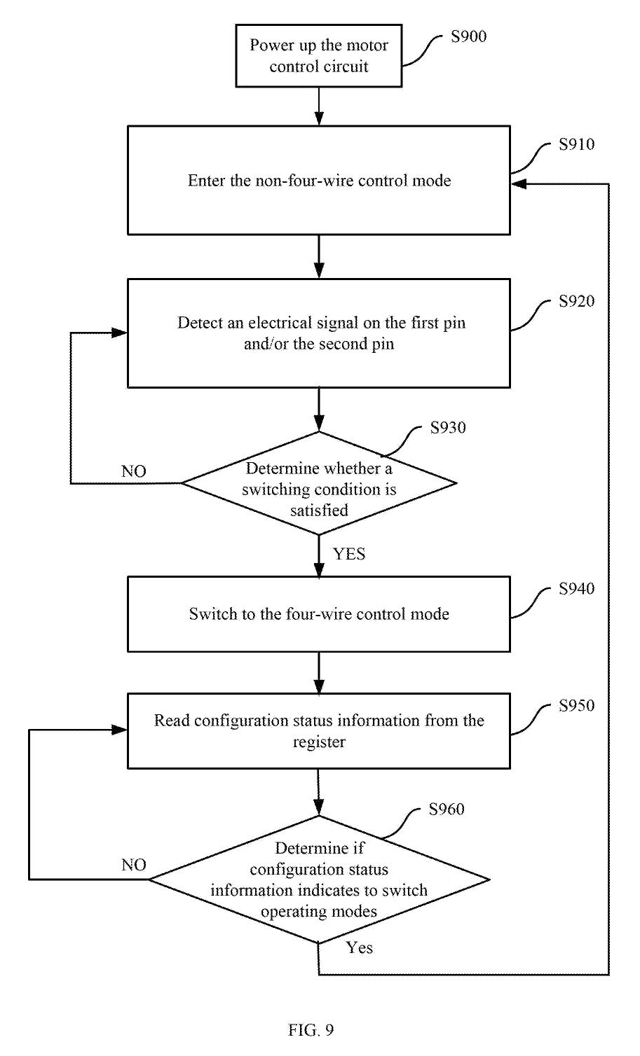

Referring now to FIG. 9, shown is a flowchart of an example control method for a motor control circuit, in accordance with embodiments of the present invention. In this particular example, the control method can include, at S900, power up of the motor control circuit. At S910, the non-four-wire control mode can be entered. That is, in response to the motor control circuit being powered on, the circuit can default to entering the non-four-wire control mode. At S920, an electrical signal can be detected on the first pin and/or the second pin. At S930, the circuit can determine whether a switching condition is satisfied.

At S940, in response to detecting a mode switching signal on the first pin, the circuit can switch to the four-wire control mode, where the mode switching signal has a predetermined frequency and/or duty cycle. In some examples, the frequency, duty cycle, and duration of the signal can be used to determine whether the switching condition is satisfied. For example, the switching condition can be that the frequency of the electrical signal falls within a switching frequency range (e.g., 150-400 kHz), the duty cycle of the electrical signal falls within a predetermined duty cycle range (e.g., 40%-60%), and the duration of the electrical signal exceeds a switching threshold (e.g., 17 microseconds). The switching frequency range can be different from the communication signal frequency range of the communication interface and the frequency range of the speed control signal.

The motor control circuit can include a first pin for receiving a speed control signal, and a second pin for sending a feedback signal. In the four-wire control mode, the first pin of the motor control circuit can be multiplexed as a first signal terminal of a communication interface, and the second pin of the motor control circuit can be multiplexed as a second signal terminal of the communication interface. At S950, in the four-wire control mode, configuration status information can be read from the register.

At S960, whether the configuration status information indicates to switch operating modes can be determined. In response to the configuration status information indicating an exit from the four-wire control mode, the flow can return to S910 to switch to the non-four-wire control mode. Otherwise, the flow can return to S950. For example, if multiple non-four-wire control modes exist, the circuit can switch to a corresponding one of the non-four-wire control modes based on different configuration status information. For example, in the four-wire control mode, reading from and writing to the register can be performed based on the input signal on the first pin and/or the input signal on the second pin.

In one particular example, the method can also include, in response to detecting the mode switching signal, enabling four-wire control mode enable signal EN_4W in the register. In one particular example, the method can also include, when operating in the four-wire control mode, controlling the motor control circuit to exit the four-wire control mode by disabling four-wire control mode enable signal EN_4W.

Particular embodiments may thus utilize the signal characteristics of the pins used for transmitting and receiving signals of the motor control circuit in the four-wire control mode to transmit a mode switching signal via the corresponding pins. If a signal on a corresponding pin satisfies a switching condition in the non-four-wire control mode, the circuit can switch to the four-wire control mode. In this way, the host controller can conveniently switch between the four-wire control mode and the non-four-wire control mode at any time. This can reduce the response speed requirements for other system components and facilitate R&D debugging.

The embodiments were chosen and described in order to best explain the principles of the invention and its practical applications, to thereby enable others skilled in the art to best utilize the invention and various embodiments with modifications as are suited to particular use(s) contemplated. It is intended that the scope of the invention be defined by the claims appended hereto and their equivalents.

What is claimed is:

1. A motor control circuit, comprising:
a) a first pin;
b) a second pin;
c) a control logic circuit configured to control a motor based on a control signal received on the first pin, and to transmit a feedback signal representing operating information of the motor to the second pin in a non-four-wire control mode;
d) a data communication circuit configured to use the first pin as a first signal terminal of a communication interface and the second pin as a second signal terminal of the communication interface in a four-wire control mode;
e) wherein an operating frequency and/or duty cycle of the non-four-wire control mode is different from that of the four-wire control mode; and
f) wherein the motor control circuit is configured to determine whether to switch to the four-wire control mode according to whether a mode switching signal is detected on the first pin or the second pin, wherein the mode switching signal has a predetermined frequency and/or duty cycle.

2. The motor control circuit of claim 1, further comprising:
a) a register configured to store configuration status information;
b) wherein in the non-four-wire control mode, when detecting the mode switching signal, the motor control circuit is configured to configure the configuration status information to enter the four-wire control mode; and
c) wherein in the four-wire control mode, when the configuration status information indicates to exit the four-wire control mode, the motor control circuit is configured to switch to the non-four-wire control mode.

3. The motor control circuit of claim 1, further comprising:
a) a first multiplexing circuit configured to receive a four-wire control mode enable signal, and being coupled to the first pin, the control logic circuit, and the data communication circuit; and
b) a second multiplexing circuit configured to receive the four-wire control mode enable signal, and being coupled to the second pin, the control logic circuit, and the data communication circuit.

4. The motor control circuit of claim 1, wherein the communication interface is an IIC serial communication interface, the first signal terminal is for transmitting a clock signal, and the second signal terminal is for transmitting a data signal.

5. The motor control circuit of claim 3, wherein the first multiplexing circuit comprises:
a) a first input filter circuit coupled to the first pin; and
b) a first selection circuit configured to determine whether to output an output signal of the first input filter circuit to the data communication circuit according to the four-wire control mode enable signal.

6. The motor control circuit of claim 3, wherein the second multiplexing circuit comprises:
a) a reception multiplexing circuit, coupled to the second pin, the control logic circuit, and the data communication circuit, and being configured to transmit a signal received from the second pin to the control logic circuit or the data communication circuit according to the four-wire control mode enable signal; and
b) a transmission multiplexing circuit, coupled to the second pin, the control logic circuit, and the data communication circuit, and being configured to transmit a signal to be sent, generated from the control logic circuit or the data communication circuit, from the second pin according to the four-wire control mode enable signal.

7. The motor control circuit of claim 6, wherein the reception multiplexing circuit comprises:
a) a second input filter circuit coupled to the second pin; and
b) a second selection circuit configured to determine whether to output an output signal of the second input filter circuit to the data communication circuit according to the four-wire control mode enable signal.

8. The motor control circuit of claim 6, wherein the transmission multiplexing circuit comprises:
a) a first output filter circuit configured to receive a signal to be sent from the control logic circuit;
b) a second output filter circuit configured to receive a signal to be sent from the data communication circuit;
c) a third selection circuit configured to select, according to the four-wire control mode enable signal, an output signal of one of the first output filter circuit and the second output filter circuit as a first switch control signal; and
d) a first switch coupled between the second pin and a reference terminal, configured to be turned on or off controlled by the first switch control signal.

9. The motor control circuit of claim 1, further comprising:
a) a third pin configured to serve as the first signal terminal of the communication interface in the non-four-wire control mode; and
b) a fourth pin configured to serve as the second signal terminal of the communication interface in the non-four-wire control mode.

10. The motor control circuit of claim 9, further comprising:
a) a third multiplexing circuit configured to receive a four-wire control mode enable signal, and coupled to the third pin, the first pin, the control logic circuit, and the data communication circuit; and
b) a fourth multiplexing circuit configured to receive the four-wire control mode enable signal, and coupled to the fourth pin, the second pin, the control logic circuit, and the data communication circuit.

11. The motor control circuit of claim 10, wherein the third multiplexing circuit comprises:
a) a third input filter circuit coupled to the first pin;
b) a fourth input filter circuit coupled to the third pin; and
c) a fourth selection circuit configured to select, according to the four-wire control mode enable signal, an output signal of one of the third input filter circuit and the fourth input filter circuit to output to the data communication circuit.

12. The motor control circuit of claim 10, wherein the fourth multiplexing circuit comprises:
a) a reception multiplexing circuit coupled to the second pin, the fourth pin, the control logic circuit, and the data communication circuit, and being configured to transmit a signal received from the second pin or the fourth pin to the control logic circuit or the data communication circuit according to the four-wire control mode enable signal; and
b) a transmission multiplexing circuit coupled to the second pin, the fourth pin, the control logic circuit, and the data communication circuit, and being configured to transmit a signal to be sent, generated from the control logic circuit or the data communication circuit, from the second pin or the fourth pin according to the four-wire control mode enable signal.

13. The motor control circuit of claim 12, wherein the reception multiplexing circuit comprises:
a) a fifth input filter circuit coupled to the second pin;
b) a sixth input filter circuit coupled to the fourth pin; and
c) a fifth selection circuit configured to select, according to the four-wire control mode enable signal, an output signal of one of the fifth input filter circuit and the sixth input filter circuit to output to the data communication circuit.

14. The motor control circuit of claim 12, wherein the transmission multiplexing circuit comprises:
a) a third output filter circuit configured to receive a signal to be sent from the control logic circuit;
b) a fourth output filter circuit configured to receive a signal to be sent from the data communication circuit;
c) a sixth selection circuit configured to select, according to the four-wire control mode enable signal, an output signal of one of the third output filter circuit and the fourth output filter circuit as a second switch control signal;
d) a second switch coupled between the second pin and a reference terminal, and being configured to be turned on or off controlled by the second switch control signal; and
e) a third switch coupled between the fourth pin and a reference terminal, and being configured to be turned on or off controlled by the output signal of the fourth output filter circuit.

15. The motor control circuit of claim 1, wherein the motor control circuit is configured to enter the non-four-wire control mode in response to power-up.

16. The motor control circuit of claim 1, wherein the mode switching signal has a frequency within a switching frequency range, a duty cycle within a predetermined duty cycle range, and a duration greater than a switching threshold, and wherein the switching frequency range is different from a frequency range of a communication signal of the communication interface and a frequency range of the control signal.

17. A motor assembly, comprising the motor control circuit of claim 1, and a motor, wherein the motor control circuit is configured to control the motor.

18. An electronic device, comprising the motor assembly of claim 17, and a host controller, wherein the motor assembly is coupled to the host controller.

19. A method of operating a motor control circuit, the method comprising:
a) determining whether to switch to a four-wire control mode by detecting whether a mode switching signal is detected on a first pin and/or a second pin, wherein the mode switching signal has a predetermined frequency and/or duty cycle;
b) wherein an operating mode of the motor control circuit comprises the four-wire control mode and a non-four-wire control mode, and an operating frequency and/or duty cycle of the four-wire control mode and the non-four-wire control mode are different;
c) wherein the first pin is used as a first signal terminal of a communication interface and the second pin is used as a second signal terminal of the communication interface in the four-wire control mode; and
d) wherein a motor is controlled based on a control signal received on the first pin, and a feedback signal representing operating information of the motor is transmitted to the second pin in the non-four-wire control mode.

20. The method of claim 19, further comprising:
a) in the non-four-wire control mode, when detecting the mode switching signal, configuring configuration status information to enter the four-wire control mode; and
b) in the four-wire control mode, when the configuration status information indicates to exit the four-wire control mode, switching to the non-four-wire control mode corresponding to the configuration status information.
